(19) United States
(12) Patent Application Publication
(10) Pub. No.: US 2024/0070619 A1
(43) Pub. Date: Feb. 29, 2024

(54) ENHANCED WIRELESS DEVICE-BASED ATTENDANCE FUNCTIONALITY

(71) Applicant: Usource Technology, LLC, Houston, TX (US)

(72) Inventor: Alexander Melgar, Houston, TX (US)

(73) Assignee: Usource Technology, LLC, Houston, TX (US)

(21) Appl. No.: 18/456,563

(22) Filed: Aug. 28, 2023

Related U.S. Application Data
(60) Provisional application No. 63/401,278, filed on Aug. 26, 2022.

(51) Int. Cl. G06Q 10/1091; H04W 4/02; H04W 4/029

(52) U.S. Cl. CPC G06Q 10/1091; H04W 4/023; H04W 4/029

(57) ABSTRACT

Devices, systems, and methods are provided for enforcing user attendance. A method may include: identifying, by a first device, first device location data of a second device at a first time; determining, based on the first device location data, that the second device is within a geo-fenced area at the first time; generating, based on the determination that the second device is within the geo-fenced area at the first time, a clock-in indication for a user associated with the second device; identifying second device location data of the second device at a second time after the first time; determining, based on the second device location data, that the second device is not within the geo-fenced area at the second time; and causing presentation, at the second device, of an indication that the user has an amount of time to return to the geo-fenced area before being clocked-out.

### CROSS-REFERENCE TO RELATED PATENT APPLICATION(S)

This application claims the benefit of U.S. Provisional Application No. 63/401,278, filed Aug. 26, 2022, the disclosure of which is incorporated herein by reference as if set forth in full

### TECHNICAL FIELD

This disclosure generally relates to devices, systems, and methods for managing attendance based on wireless device information.

### BACKGROUND

Logging attendance may be tedious, inefficient, and prone to inaccuracy. People often have to enter the times when they enter and leave a site, including for breaks and emergencies. Systems may lack the ability to automatically detect when a person departs from a location, and the ability to determine whether to clock out the person once they have departed from the location.

### BRIEF DESCRIPTION OF THE DRAWINGS

FIG. 1 illustrates an example environment for enhanced wireless device-based attendance, in accordance with one or more example embodiments of the present disclosure.

FIG. 2 illustrates an example system for enhanced wireless device-based attendance, in accordance with one or more example embodiments of the present disclosure.

FIG. 3A depicts example interfaces for enhanced wireless device-based attendance, in accordance with one or more example embodiments of the present disclosure.

FIG. 3B depicts example interfaces for enhanced wireless device-based attendance, in accordance with one or more example embodiments of the present disclosure.

FIG. 4 illustrates a flow diagram of a process for enhanced wireless device-based attendance, in accordance with one or more example embodiments of the present disclosure.

FIG. 5 is a block diagram illustrating an example of a computing device or computer system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

To improve attendance logging accuracy and reduce the need to manually enter clock-in and clock-out times used for attendance records, device location data may be monitored (with user consent and in accordance with relevant laws).

Geo-fencing may be used to determine, based on a user device location, whether a user possessing the user device has entered a geo-fenced area and whether the user has departed from the geo-fenced area.

However, some systems using wireless device and geo-fencing data lack the ability to customize the determination of when a user should be clocked out based on the detection of a user device departing from a geo-fenced area, to use a user's wireless location to determine whether to allow a user to clock into a site, to allow users to see multiple locations with geo-fenced clock-in/clock-out in a same user interface, and to customize an exchange of data with the user to confirm that the user intends to depart from and be clocked out from a geo-fenced area.

There is therefore a need for enhanced wireless device-based attendance functionality.

In one or more embodiments, an attendance system may use geo-fencing to specify one or more virtual perimeters. For example, a virtual perimeter may correspond to a place of work, a school, a home, or another location where the attendance system may be used to determine when a person is within or outside of the geo-fenced area.

In one or more embodiments, the attendance system may, with user consent and in accordance with relevant laws, use mobile device wireless data, such as cellular network data, to determine a device's location. When the mobile device's location is within the geo-fenced area, the attendance system may consider the user of the device present within the geo-fenced area. In this manner, when mobile device data may indicate when a person has entered the geo-fenced area and when the person has departed the geo-fenced area.

In one or more embodiments, when the attendance system detects that a person has entered a geo-fenced area, the attendance system may automatically enter a clock-in (e.g., arrival) time for the person for the purposes of logging a person's time within the geo-fenced area. Alternatively or in addition, when a person requests to clock into a location, the attendance system may respond to the request by verifying whether the person's device is within the geo-fenced area for the location prior to allowing the user to clock into the location. In this manner, clocking into a location may ensure that a person is actually on-site (e.g., within a geo-fenced area for the site) when clocking in for a site (e.g., a job, an appointment, or the like).

In one or more embodiments, when the attendance system detects that the person has departed the geo-fenced area, the attendance system may automatically enter a clock-out (e.g., departure) time for the person for the purposes of logging a person's time within the geo-fenced area. Alternatively or in addition, a user may use their mobile device to clock in and clock out of a geo-fenced area (e.g., by entering their clock-in and clock-out times through one or more user interfaces presented using their mobile devices), and the clock-in and clock-out times may be sent to the attendance system to verify that the mobile device location data verifies that the user is within or outside of the geo-fenced area.

In one or more embodiments, after a user has been clocked-in and verified to be within a geo-fenced area (e.g., based on the wireless device data), the attendance system periodically may verify that the wireless device data indicate that the user is still within the geo-fenced area. When the attendance system detects that the user is no longer within the geo-fenced area, the attendance system may send one or more notifications to the user's device, or to another user device (e.g., in case the user inadvertently left their other device outside of the geo-fenced area, but the user has returned to the geo-fenced area), to indicate that the attendance system has detected that the user has departed the geo-fenced area and either will be clocked-out automatically, or that the user has a certain amount of time to return to the geo-fenced area to prevent being clocked-out automatically. The one or more notifications may trigger a timer that allows the user to return to the geo-fenced area prior to expiration without automatically clocking-out the user, and that when the timer expires prior to detecting the user's device has returned to the geo-fenced area, may automatically clock-out the user. In this manner, the user may be given time upon detection of their device outside of the geo-fenced area to return to the geo-fenced area before being clocked-out/counted as absent, or to provide another indication that they are within the geo-fenced area (e.g., but are without their device, which may have been left outside of the geo-fenced area).

In one or more embodiments, whether to allow for the notifications and time to return to the geo-fenced area, and how much time to allow, may be user-selectable options presented to a user (e.g., a user having certain permissions) via a user interface of the attendance system. For example, the user interface may allow selectable clock-in/clock-out options such as allowing clock-in only in a geo-fenced location (e.g., conditioning a person's clock-in time on their device being within a geo-fenced location), allowing clock-in only for scheduled jobs/activities (e.g., clocking the user in when the device is within a geo-fenced area during a scheduled time for the person to be within the geo-fenced area), and/or allowing auto-clock-out if a user is outside the geo-fenced area for a certain amount of time that may be customizable (e.g., set by a user).

In one or more embodiments, notifications to a user indicating that the user has been detected as leaving a geo-fenced area may instruct the user to return to a an assigned location corresponding to the geo-fenced area, and/or allowing the user to input an indication that the user intends to leave and clock-out from the geo-fenced area. The notifications also may include details such as the user's location, the geo-fenced location, the user's location relative to the geo-fenced location, and/or directions from the user's location to the geo-fenced area.

In one or more embodiments, a user may have multiple appointments/jobs at different locations. For example, a user may have a job at one site in the morning, and another job at another site in the afternoon. The user may have an appointment on the same day as well. Rather than the user needing to access different systems for the respective jobs, appointments, etc. to clock-in and clock-out, the attendance system may consolidate the user's jobs and appointments into a single user interface with which the user can see any of their jobs and appointments on any particular day, and may clock into and out of the jobs and appointments based on whether the user is within the geo-fenced area of a respective job or appointment, and/or the time of day relative to when the job or appointment is scheduled. For example, the user interface may present jobs and appointments that a user has scheduled on a particular day, along with information regarding their locations and times, and clock-in/clock-out options that the user may select from the user interface to request a clock-in or clock-out. When the user selects a clock-in request, the attendance system may verify whether the user is within the geo-fence set for the job or appointment to which the user is requesting to be clocked-in, and may process the request when the user is within the geo-fenced area (or may notify the user that they cannot clock-in until they are within the geo-fenced area).

In one or more embodiments, the attendance system may facilitate clocking into a job or appointment by providing user information (with user consent and in accordance with relevant privacy laws) to a job or appointment. For example, clocking into a job or appointment may include providing photo of the person and/or biometric data, such as a fingerprint. When the user's device is capable of generating the photo and/or biometric data, a request to clock-in that is accepted based on the user being within the geo-fenced area may result in an application prompting the user to generate the photo and/or biometric data. Alternatively, the user's device may access a stored photo and/or biometric data. The user's device may transmit, to a job or appointment (e.g., one or more devices linked to the job or appointment, or to a device within the attendance system when accessible to users of the job or appointment location) the photo and/or biometric data along with a request to clock-in the user when the user is within the geo-fenced area. The photo may be used in facial recognition (e.g., by the attendance system or a device of the job or appointment) to verify the user's identity, and/or to generate a badge or other identifier of the user. Clocking into a location may be conditioned upon verifying the user's face and/or biometric information.

In one or more embodiments, satellite waves may be used to improve location detection accuracy. Satellite waves may use global positioning services (GPS) satellites to communicate with wireless devices at high frequencies (e.g., higher than radio frequency waves) to communicate location, date, and time information. To facilitate the use of satellite wave communications, wireless devices may have an on-board GPS satellite transceivers to communicate with GPS satellites using satellite waves. The GPS satellites may send satellite wave transmissions to the wireless devices to provide location, date, and time information, and the wireless devices may use the information to determine their location (e.g., based on respective positions relative to multiple GPS satellites). Because the wireless devices may provide their more accurate location data, based on the satellite wave transmissions, the attendance system may accurately detect a wireless device location relative to geo-fences. Due to propagation time and/or time intervals between respective satellite wave transmissions, the attendance system may rely on consecutive location determinations of wireless devices based on consecutive satellite wave transmissions to detect whether a device has departed from a geo-fenced area.

In one or more embodiments, there may be a limited number of devices signed into (e.g., authenticated by) the attendance system at a given time. For example, if a user is signed into the attendance system with a first device and then signs into the attendance system with a second device, the attendance system may log out the first device and rely on the location data of the second device for evaluating attendance.

The above descriptions are for purposes of illustration and are not meant to be limiting. Numerous other examples, configurations, processes, etc., may exist, some of which are described in greater detail below. Example embodiments will now be described with reference to the accompanying figures.

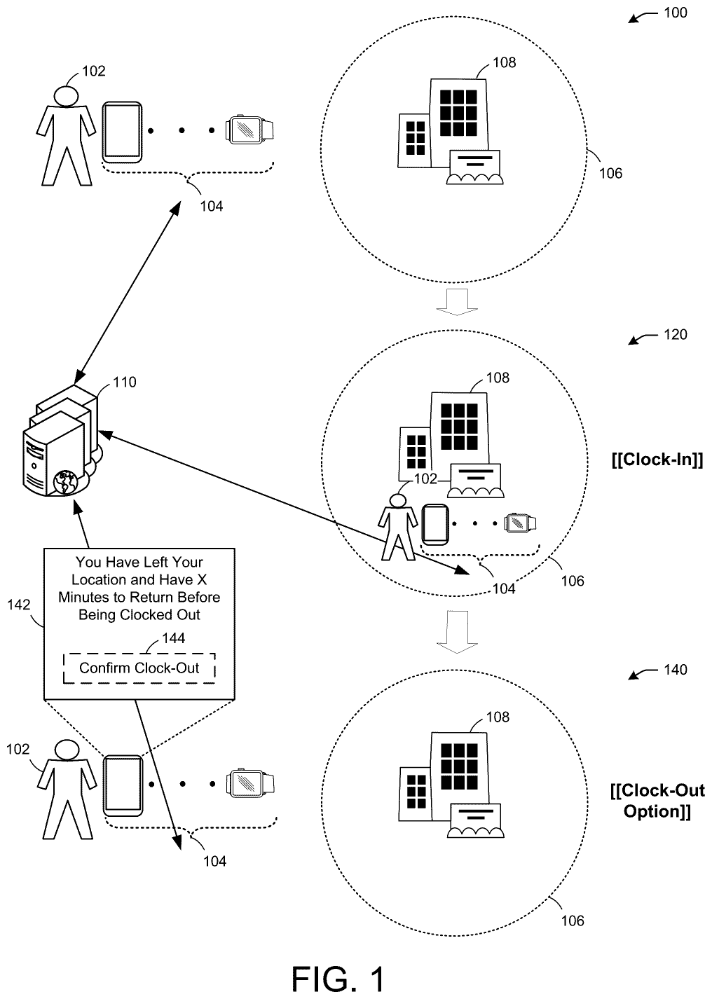

FIG. 1 illustrates an example environment for enhanced wireless device-based attendance, in accordance with one or more example embodiments of the present disclosure.

Referring to FIG. 1, at step 100 (e.g., a first time), a user 102 having one or more devices 104 may be outside of a geo-fenced area 106 representing a physical location 108. The geo-fenced area 106 may correspond to location coordinates, and when the location coordinates of the one or more devices 104 are outside of the geo-fenced area 106 coordinates, an attendance system 110 may detect that the user 102 is not within the geo-fenced area 106. In this manner, the one or more devices 104 may, with user consent and in accordance with relevant laws, provide their location data to the attendance system 110.

Still referring to FIG. 1, at step 120 (e.g., a second time after the first time), the user 102 and the one or more devices 104 may be within the geo-fenced area 106. The one or more devices 104 may provide their location data to the attendance system 110, which may determine that the location data indicate that the one or more devices 104, and therefore the user 102, are within the geo-fenced area. When the user 102 is detected as being within the geo-fenced area, the attendance system 110 may generate a clock-in notification to indicate the presence of the user 102 within the geo-fenced area 106 at the second time. Alternatively, the user 102 may request the attendance system 110 (e.g., using the one or more devices 104) to clock the user 102 into a job or an appointment, and the attendance system 110 may verify whether the user 102 is within the geo-fenced area as a condition for allowing the user 102 to clock-in for a job or an appointment in the geo-fenced area.

Still referring to FIG. 1, at step 140, the user 102 and the one or more devices 104 may have departed the geo-fenced area 106 (e.g., are no longer within the geo-fenced area 106). The location data provided by the one or more devices 104 to the attendance system 110 may indicate to the attendance system 110 that the one or more devices 104, and therefore the user 102, have departed the geo-fenced area 106 at the third time. Based on this determination, the attendance system 110 may automatically generate a clock-out notification for the user 102, or may present one or more notifications 142 indicating the detection of the user 102 being outside of the geo-fenced area. The one or more notifications 142 may indicate that the user 102 has an amount of time to return to within the geo-fenced area 106 to avoid the clock-out generation, and when the amount of time expires, the user 102 may be considered clocked-out when the one or more devices 104 do not provide location data indicating that the one or more devices 104 have returned to the geo-fenced area 106. The one or more notifications 142 may include a user option to confirm a clock-out event (e.g., a user request to clock-out the user 102), and may provide additional details such as date, time, location, directions back to the geo-fenced area, appointment/job details indicating why the user 102 is supposed to be at the physical location 108 and/or differentiating between jobs/appointments.

In one or more embodiments, the one or more devices 104 and/or the attendance system 110 may include client devices, server devices, smart devices, Internet of Things (IoT) devices, wearable devices, or the like.

In one or more embodiments, the user 102 may have multiple appointments/jobs at different locations. For example, the user 102 may have a job at one site in the morning, and another job at another site in the afternoon. The user 102 may have an appointment on the same day as well. Rather than the user needing to access different systems for the respective jobs, appointments, etc. to clock-in and clock-out, the attendance system 110 may consolidate the user's jobs and appointments into a single user interface with which the user 102 can see (e.g., using the one or more devices 104, which may access the attendance system 110) any of their jobs and appointments on any particular day, and may clock into and out of the jobs and appointments based on whether the user 102 is within the geo-fenced area 106 of a respective job or appointment, and/or the time of day relative to when the job or appointment is scheduled. For example, the user interface may present jobs and appointments that the user 102 has scheduled on a particular day, along with information regarding their locations and times, and clock-in/clock-out options that the user 102 may select from the user interface to request a clock-in or clock-out. When the user 102 selects a clock-in request, the attendance system 110 may verify whether the user 102 is within the geo-fence set for the job or appointment to which the user 102 is requesting to be clocked-in, and may process the request when the user 102 is within the geo-fenced area 106 (or may notify the user 102 that they cannot clock-in until they are within the geo-fenced area 106).

In one or more embodiments, the attendance system 110 may facilitate clocking into a job or appointment by providing user information (with user consent and in accordance with relevant privacy laws) to a job or appointment. For example, clocking into a job or appointment may include providing photo of the user 102 and/or biometric data, such as a fingerprint. When the user's device (e.g., the one or more devices 104) is capable of generating the photo and/or biometric data, a request to clock-in that is accepted based on the user 102 being within the geo-fenced area 106 may result in an application running on the one or more devices 104 prompting the user 102 to generate the photo and/or biometric data. Alternatively, the user's device may access a stored photo and/or biometric data. The user's device may transmit, to a job or appointment (e.g., one or more devices linked to the job or appointment, or to a device within the attendance system 110 when accessible to users of the job or appointment location) the photo and/or biometric data along with a request to clock-in the user 102 when the user 102 is within the geo-fenced area 106.

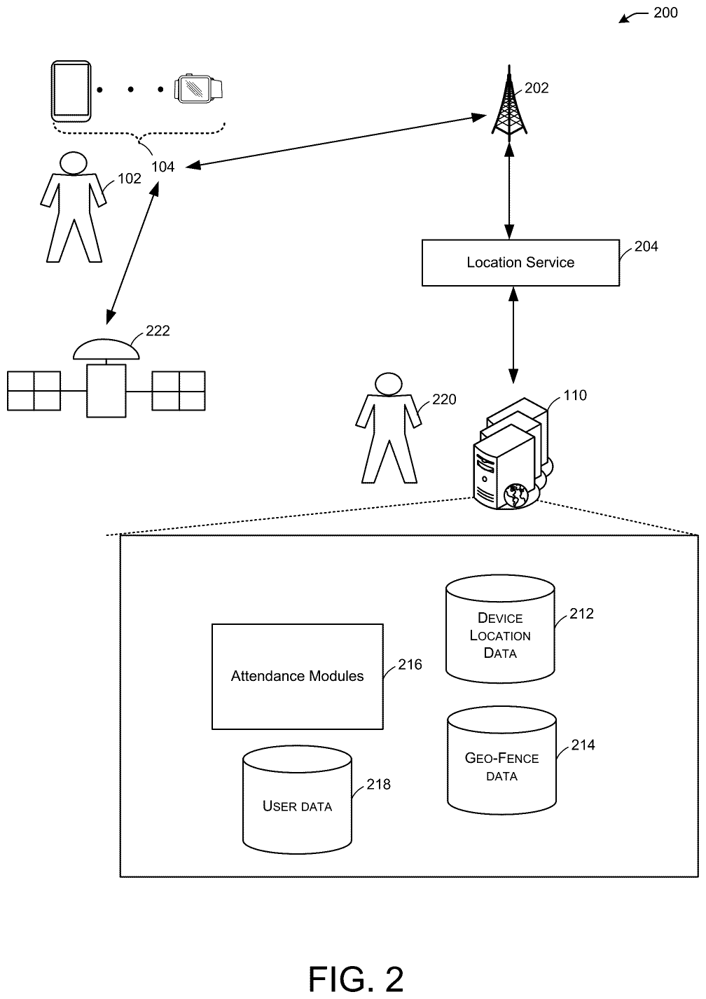

FIG. 2 illustrates an example system 200 for enhanced wireless device-based attendance, in accordance with one or more example embodiments of the present disclosure.

Referring to FIG. 2, the system 200 may include the user 102, the one or more devices 104, and the attendance system 110. The one or more devices 104 may communicate their location data via one or more wireless networks 202 (e.g., cellular, Wi-Fi, etc.), which may provide indications of the location data to a location service 204. The location service 204 may provide the location data to the attendance system 110, and may be part of the attendance system 110 or may be a third-party service. The attendance system 110 may include a database 212 for device location data and a database 214 for geo-fenced data (e.g., coordinates for geo-fences, physical locations located within the geo-fenced area, job/appointment data for users at respective geo-fenced areas, and the like). Attendance modules 216 may compare the device location data to the geo-fence data to determine whether devices are within or outside of geo-fenced areas at different times, may generate clock-in and clock-out notifications, and may generate and send notifications to the one or more devices 104. User data 218 may include photos and/or biometric data that may be used to verify the user 102 and/or create a badge or other identifier for the user 102 (e.g., the user data 218 may be stored, provided, and used in accordance with user consent and relevant privacy laws).

Still referring to FIG. 2, the settings used for analysis and notification generation of the attendance system 110 may be input by one or more users 220 (e.g., administrators, etc.). For example, the one or more users 220 may provide the geo-fence data, and/or settings such as whether to allow clock-in only on scheduled jobs/appointments, whether to allow clock-in only when a device is within a geo-fenced area, and/or whether to allow clock-out immediately upon detection of a device having departed a geo-fenced area or whether to allow for a time period for a user to return to a geo-fenced area prior to clock-out.

Still referring to FIG. 2, the one or more devices 104 may determine and provide their location data based on radio frequency waves (e.g., transmissions with the one or more wireless networks 202) and/or based on satellite waves (e.g., transmissions with one or more satellites 222, such as GPS satellites).

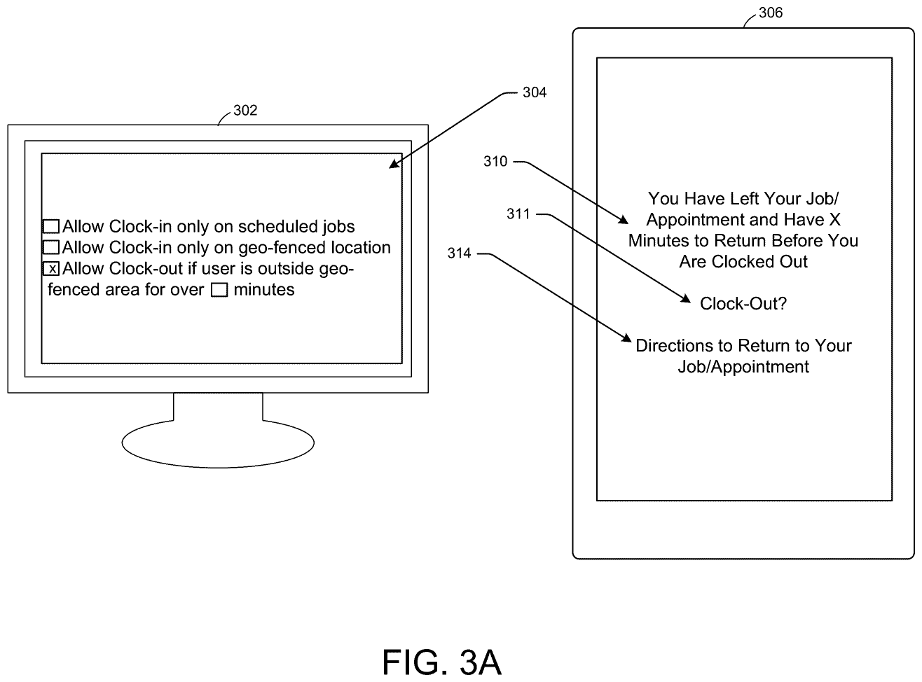

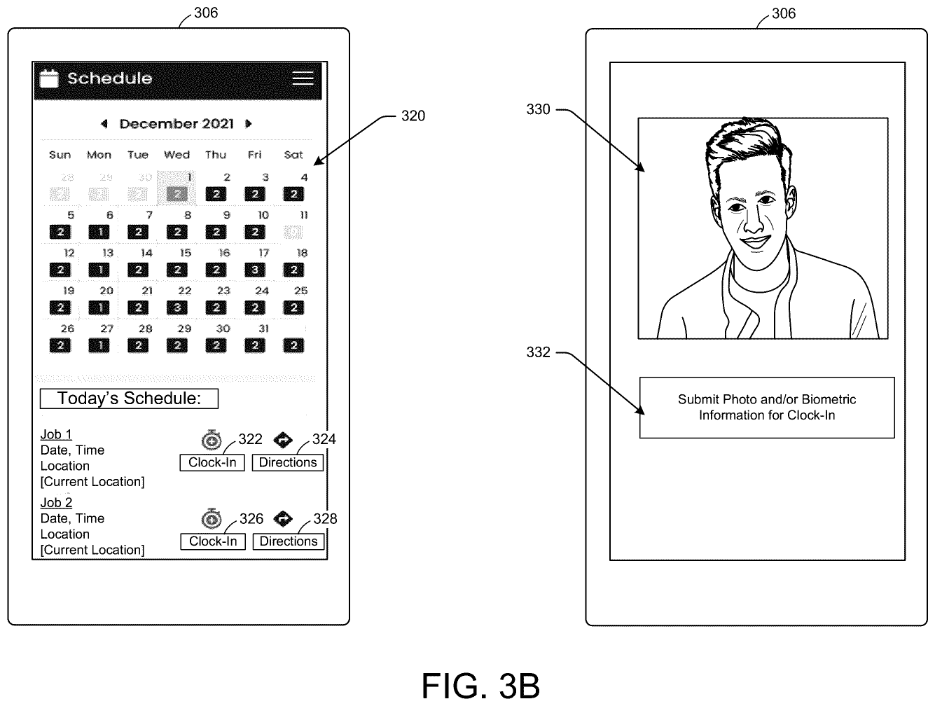

FIG. 3A depicts example interfaces for enhanced wireless device-based attendance, in accordance with one or more example embodiments of the present disclosure.

Referring to FIG. 3, a device 302 may present user interface data 304 (e.g., to the one or more users 220 of FIG. 2) allowing for customized settings of clock-in and clock-out features of the attendance system 110 of FIG. 1. For example, a user may select, from the user interface data 304, an option to allow clock-in only for scheduled jobs/appointments (e.g., when a device is within a geo-fenced area during a scheduled time for a job/appointment), to allow clock-in only on a geo-fenced location (e.g., only generate a clock-in when a device is within a geo-fenced area), and/or to allow for time to return to a geo-fenced area prior to clocking a user out.

Still referring to FIG. 3A, a device 306 (e.g., similar to the one or more devices 104 of FIG. 1) may present user interface data (e.g., indicative of dates/times), including user interface data 310 (e.g., indicating notifications that a user is outside of a geo-fenced area and has an amount of time to return to avoid being clocked-out), user interface data 311 (e.g., providing an option for the user to confirm that they are clocking out), and/or user interface data 312 (e.g., directions from a device location to the geo-fenced area, coordinates within the geo-fenced area, such as those of a physical location).

FIG. 3B depicts example interfaces for enhanced wireless device-based attendance, in accordance with one or more example embodiments of the present disclosure.

Referring to FIG. 3B, the device 306 may present user interface data 320 representing a single user interface with which multiple jobs and/or appointments may be presented concurrently with options to clock into and out of the jobs/appointments. For example, as shown in FIG. 3B, job 1 and job 2 are shown, but more jobs on a particular day or days may be presented concurrently. Job 1 is shown with a clock-in option 322 and clock-out option 324, and job 2 is shown with a clock-in option 326 and clock-out option 328. When a user selects a clock-in or clock-out option, the attendance system 110 of FIG. 1 may verify that the user is within a geo-fenced area for a job at that date and time before allowing the user to clock-in (or transmit or otherwise submit the user's request to clock-in). The user interface data 320 may show an indication of the user's current location to notify the user that they are near or within a geo-fenced area of one of the jobs (e.g., the user's current location is shown as within the geo-fenced area of job 1 in FIG. 3B).

Still referring to FIG. 3B, when the user selects a clock-in option (e.g., the clock-in option 322) as a request to clock into a geo-fenced area, the device may allow the user to send a photo 330 and/or biometric data (not shown) to the attendance system 110 and/or to another device to verify the user's identity and/or to create a badge or other identifier for a job/appointment. The device 306 automatically may generate or retrieve a stored photo or biometric data and transmit the information with the clock-in request, or may prompt the user with an option 332 to submit the photo and/or biometric information.

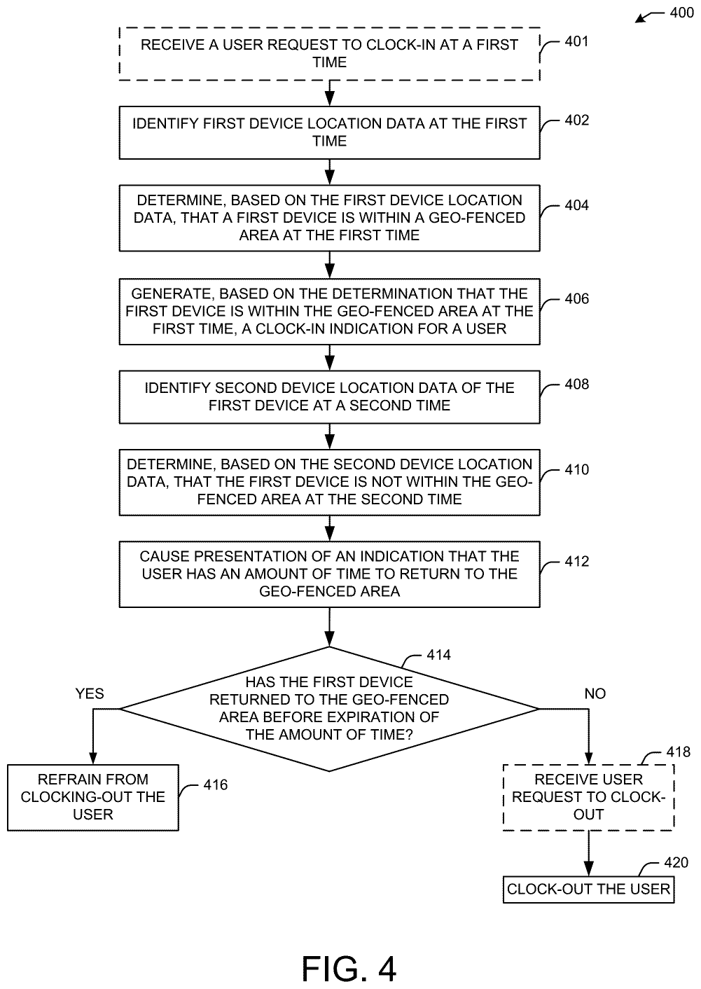

FIG. 4 illustrates a flow diagram of a process 400 for enhanced wireless device-based attendance, in accordance with one or more example embodiments of the present disclosure.

At block 401, a device (or system, e.g., the attendance system 110 of FIG. 1) optionally may receive a user request to clock-in (e.g., to a job/appointment) at a first time. For example, a user may select the clock-in option 322 of FIG. 3B. The device may automatically clock-in the user when the user's device (e.g., the one or more devices 104 of FIG. 1) is detected as within a geo-fence of a job/appointment that the user has scheduled at or within a threshold amount of time of the first time. Alternatively, the user may request the clock-in at block 401.

At block 402, the device may identify first device location data at a first time, such as location data of one of the devices 104 of FIG. 1 at step 100. The location data may include GPS positioning data determined by the first device based on wireless network and/or satellite wave transmissions.

At block 404, the device may determine, based on the first device location data, that the first device is within a geo-fenced area at the first time. The device may, for example, compare the first device location data to geo-fence data to determine whether the first device, and therefore its user, is at a location within a geo-fenced area at the first time.

At block 406, the device may generate, based on the determination that the first device is within a geo-fenced area at the first time, a clock-in indication (e.g., clock-in request) for the user of the device (e.g., step 120 of FIG. 1). The clock-in indication may be generated automatically based on detection of the first device being within the geo-fenced area, or may be generated after the request by the user at block 401 is validated by confirming that the first device is within the geo-fenced area, and/or whether the user is scheduled to be within the geo-fenced area at the first time. The device may submit additional information for the clock-in indication, such as a photo and/or biometric data (e.g., as shown in FIG. 3B). The device may present a user interface showing multiple locations where a person is scheduled to be on a particular date, and the clock-in indication may be presented with one of the locations corresponding to the geo-fenced area in which the first device is identified as being located. In this manner, the clock-in indication may indicate that the user is permitted to clock-in (e.g., automatically based on being in the geo-fenced area, or based on a user request to clock-in, which may or may not include providing additional data such as a photo or biometric data) to that location at that time (e.g., as shown in FIG. 3B).

At block 408, the device may identify second device location data of the first device at a second (e.g., later) time. The location data may include GPS positioning data determined by the first device based on wireless network and/or satellite wave transmissions.

At block 410, the device may determine, based on the second device location data, that the first device is no longer within the geo-fenced area at the second time. The device may, for example, compare the second device location data to geo-fence data to determine whether the first device, and therefore its user, is at a location within a geo-fenced area at the second time. Because the first location data may indicate that the first device is within the geo-fenced area at a first time, and the second location data may indicate that the first device is not within the geo-fenced area at the second time, the device may determine that the first device has departed from the geo-fenced area between the first time and the second time.

At block 412, the device may cause presentation (e.g., at the first device or another device) of an indication that the user has an amount of time to return to the geo-fenced area (e.g., the one or more notifications 142 of FIG. 1). The amount of time may be based on a user setting selected by a user (e.g., FIG. 3).

At block 414, the device may determine, based on third location data of the first device, whether the first device has returned to the geo-fenced area before expiration of the amount of time. Because multiple locations of the first device may be reported prior to the expiration of the amount of time, an updated location of the first device after the second time may not automatically result in clocking out the user, as the user may still have time to return to the geo-fenced area. However, if the updated location data of the first device indicate that the user is even further away from the geo-fenced area than at the second time, the device may generate a clock-out indication for the user, or may send one or more subsequent notifications warning the user of the pending clock-out event.

At block 416, when the third location data indicate that the first device has returned to the geo-fenced area prior to expiration of the amount of time, the device may refrain from clocking out the user. At block 418, optionally, the device may receive a user request/confirmation to clock-out the user. At block 420, when the amount of time has expired or in response to a user request/confirmation to clock-out the user, the device may generate a clock-out indication to clock-out the user.

The examples described herein are not meant to be limiting.

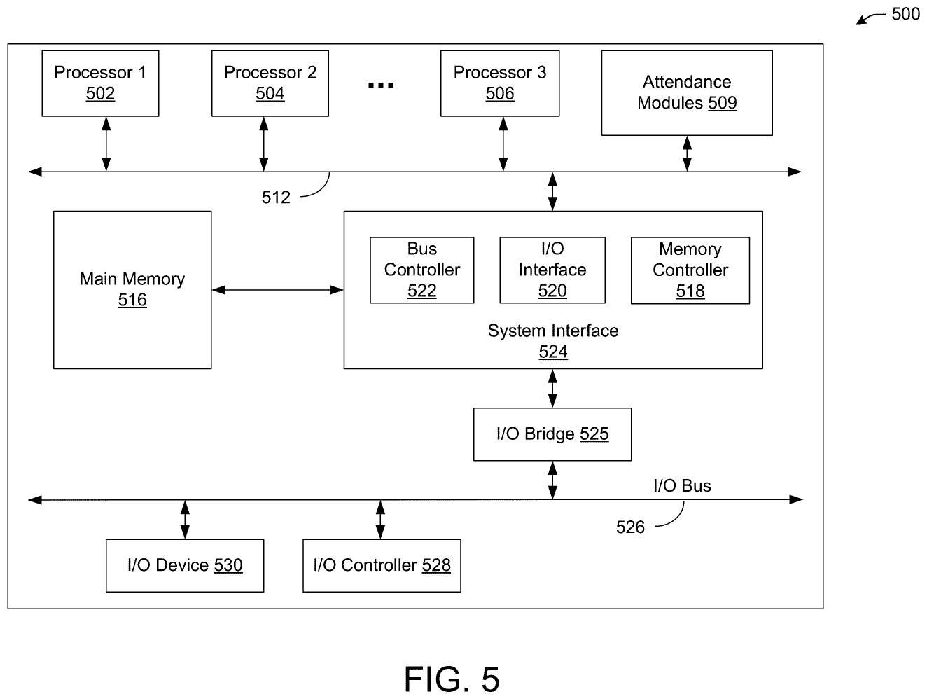

FIG. 5 is a block diagram illustrating an example of a computing device or computer system 500 upon which any of one or more techniques (e.g., methods) may be performed, in accordance with one or more example embodiments of the present disclosure.

For example, the computing system 500 of FIG. 5 may represent the one or more devices 104 of FIG. 1, the attendance system 110 of FIG. 1, the device 302 of FIG. 3, and/or the device 306 of FIG. 3, and therefore may facilitate the enhanced attendance system. The computer system (system) includes one or more processors 502-506 and one or more attendance modules 509 (e.g. representing the attendance modules 216 of FIG. 2). Processors 502-506 may include one or more internal levels of cache (not shown) and a bus controller (e.g., bus controller 522) or bus interface (e.g., I/O interface 520) unit to direct interaction with the processor bus 512.

Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices 530 (e.g., cameras, scanners, etc.) with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include read-only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. In alternative embodiments, circuitry may be used in place of or in combination with the software instructions. Thus, embodiments of the present disclosure may include both hardware and software components.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as, but not limited to, source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, solid state devices (SSDs), and the like. The one or more memory devices (not shown) may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or any other manner.

It is understood that the above descriptions are for purposes of illustration and are not meant to be limiting.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for enforcing user attendance, the method comprising:
identifying, by at least one processor of a first device, first device location data of a second device at a first time;
determining, by the at least one processor, based on the first device location data, that the second device is within a geo-fenced area associated with a first physical location at the first time;
generating, by the at least one processor, based on the determination that the second device is within the geo-fenced area at the first time, a clock-in indication indicating that a user associated with the second device is permitted to clock-in to the first physical location at the first time;
causing presentation, by the at least one processor, of a user interface presenting the first physical location, a second physical location where the user may request to clock-in at a second time, and the clock-in indication for the first physical location and the user at the first time;
identifying, by the at least one processor, second device location data of the second device at a third time after the first time;
determining, by the at least one processor, based on the second device location data, that the second device is not within the geo-fenced area at the third time; and
causing presentation, by the at least one processor, at the second device, of an indication that the user has an amount of time to return to the geo-fenced area prior to being clocked-out.

2. The method of claim 1, further comprising:
determining that the second device is not within the geo-fenced area between the third time and an expiration of the amount of time; and
generating, based on the determination that the second device is not within the geo-fenced area between the third time and the expiration of the amount of time, a clock-out indication for the user.

3. The method of claim 2, further comprising:
receiving a confirmation from the user that the user is to be clocked-out,
wherein generating the clock-out indication is based on the confirmation.

4. The method of claim 2, wherein generating the clock-out indication occurs without a confirmation from the user that the user is to be clocked-out.

5. The method of claim 1, further comprising:
determining that the second device is within the geo-fenced area between the third time and an expiration of the amount of time; and
determining to not generate a clock-out indication for the user.

6. The method of claim 1, further comprising:
identifying a user setting indicative of the amount of time,
wherein causing presentation of the indication that the user has the amount of time to return to the geo-fenced area prior to being clocked-out is based on identifying the user setting.

7. The method of claim 1, further comprising:
determining that the user is scheduled to be within the geo-fenced area at the first time,
wherein the clock-in indication is further based on the determination that the user is scheduled to be within the geo-fenced area at the first time.

8. The method of claim 1, further comprising:
receiving a request from the user to generate the clock-in indication at the first time,
wherein determining that the second device is within the geo-fenced area at the first time is based on receiving the request.

9. The method of claim 1, wherein the indication comprises directions to the geo-fenced area from a location indicated by the second device location data.

10. A device comprising memory coupled to at least one processor, the at least one processor configured to:
identify first device location data of a second device at a first time;
determine, based on the first device location data, that the second device is within a geo-fenced area associated with a first physical location at the first time;
generate, based on the determination that the second device is within the geo-fenced area at the first time, a clock-in indication indicating that a user associated with the second device is permitted to clock-in to the first physical location at the first time;
cause presentation, at the second device, of a user interface presenting the first physical location, a second physical location where the user may request to clock-in at a second time, and the clock-in indication for the first physical location and the user at the first time;
identify second device location data of the second device at a third time after the first time;
determine, based on the second device location data, that the second device is not within the geo-fenced area at the third time; and
cause presentation, at the second device, of an indication that the user has an amount of time to return to the geo-fenced area prior to being clocked-out.

11. The device of claim 10, wherein the at least one processor is further configured to:
determine that the second device is not within the geo-fenced area between the third time and an expiration of the amount of time; and
generate, based on the determination that the second device is not within the geo-fenced area between the third time and the expiration of the amount of time, a clock-out indication for the user.

12. The device of claim 11, wherein the at least one processor is further configured to:
receive a confirmation from the user that the user is to be clocked-out,
wherein to generate the clock-out indication is based on the confirmation.

13. The device of claim 11, wherein to generate the clock-out indication occurs without a confirmation from the user that the user is to be clocked-out.

14. The device of claim 10, wherein the at least one processor is further configured to:
determine that the second device is within the geo-fenced area between the third time and an expiration of the amount of time; and
determine to not generate a clock-out indication for the user.

15. The device of claim 10, wherein the at least one processor is further configured to:
identify a user setting indicative of the amount of time,
wherein to cause presentation of the indication that the user has the amount of time to return to the geo-fenced area prior to being clocked-out is based on identifying the user setting.

16. The device of claim 10, wherein the at least one processor is further configured to:
determine that the user is scheduled to be within the geo-fenced area at the first time,
wherein the clock-in indication is further based on the determination that the user is scheduled to be within the geo-fenced area at the first time.

17. The device of claim 10, wherein the at least one processor is further configured to:
receive a request from the user to generate the clock-in indication at the first time,
wherein to determine that the second device is within the geo-fenced area at the first time is based on receiving the request.

18. The device of claim 10, wherein the indication comprises directions to the geo-fenced area from a location indicated by the second device location data.

19. A system comprising memory coupled to at least one processor, the at least one processor configured to:
identify first device location data of a device at a first time;
determine, based on the first device location data, that the device is within a geo-fenced area associated with a first physical location at the first time;
generate, based on the determination that the device is within the geo-fenced area at the first time, a clock-in indication indicating that a user associated with the device is permitted to request to clock-in to the first physical location at the first time;
causing presentation, at the device, of a user interface presenting the first physical location, a second physical location where the user may request to clock-in at a second time, and the clock-in indication for the first physical location and the user at the first time;
identify second device location data of the device at a third time after the first time;
determine, based on the second device location data, that the device is not within the geo-fenced area at the third time; and
cause presentation, at the device, of an indication that the user has an amount of time to return to the geo-fenced area prior to being clocked-out.

20. The system of claim 19, wherein the at least one processor is further configured to:
determine that the device is not within the geo-fenced area between the third time and an expiration of the amount of time; and
generate, based on the determination that the device is not within the geo-fenced area between the third time and the expiration of the amount of time, a clock-out indication for the user.
